(19) United States
(12) Patent Application Publication
(10) Pub. No.: US 2025/0211538 A1
(43) Pub. Date: Jun. 26, 2025

(54) DYNAMIC PRIORITIZATION OF MESSAGES ON THE CORE NETWORK INTERFACE

(71) Applicant: T-MOBILE INNOVATIONS LLC, Overland Park, KS (US)

(72) Inventors: Anil Kumar MARIYANI, Ashburn, VA (US); subramania Kaushik, Bellevue, WA (US); Chris Jensen, Snoqualmie, WA (US)

(21) Appl. No.: 18/392,950

(22) Filed: Dec. 21, 2023

(51) Int. Cl. H04L 47/24; H04L 43/16; H04L 47/62; H04W 48/18

(52) U.S. Cl. CPC H04L 47/2458; H04L 43/16; H04L 47/623; H04W 48/18

(57) ABSTRACT

Embodiments of the present disclosure are directed to systems and methods for improved prioritization of messages exchanged within the core network. By providing priority markings customized based on the type of message being sent and/or the interface the message is sent on, a network may work more optimally in the event of network failure or reduced performance of the network.

### SUMMARY

The present disclosure is directed, in part to prioritizing messages exchanged in the core network at an interface level and/or at a message level, substantially as shown and/or described in connection with at least one of the figures, and as set forth more completely in the claims.

According to various aspects of the technology, network functions (NF) of the 5G core network communicate messages between each other on designated interfaces. Occasionally, a network may experience network failures caused by outages, a reduced quality of service, and the like. Priority markings may be assigned to messages to be exchanged within the core network to aid the network in deciding which messages should be processed before others in the event of reduced network performance or a network failure. Processing might include routing a message with a higher priority marking before routing a message with a lower priority marking, or it could include assembling a queue of messages to be transmitted, with the top of the queue indicating messages with the highest priority markings are to be routed before other messages with lower priority markings. Conventionally, priority markings indicate the same priority for all messages coming from the same source network component, such as the same NF, creating a bottleneck of messages to be sent because the network is unable to prioritize messages with the same priority marking. By providing priority markings customized based on the type of message being sent and/or the interface it will travel on, this bottleneck may be avoided.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of an exemplary method for dynamically prioritizing different messages types on the same and different interfaces in which implementations of the present disclosure may be employed;

FIG. 4 illustrates a flow diagram of an exemplary method for dynamically prioritizing messages between NFs in which implementations of the present disclosure may be employed; and

FIG. 5 illustrates a flow diagram of an exemplary method for dynamically prioritizing messages between NFs in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, the 5G core network is comprised of a plurality of network functions (NFs) that communicate messages to each other through interfaces. The specific interface involved in communicating between two NF components depends on the particular NF components involved in the communication. For example, if the message is between a session management function (SMF) and a policy control function (PCF), the designated interface is the N7 interface, and messages between the SMF and the PCF would occur on the N7 interface. However, for example, if the message is between an access and mobility management function (AMF) and a unified data management function (UDM), the designated interface is the N8 interface. A network may experience network failures caused by congestion, a cut fiber, IP link failures, a reduced quality of service, an outage, or some other network event affecting network performance. As a result, messages may be lost or delayed in their transmission on interfaces between NFs or between servers or between other network components. In these instances, priority markings, such as a differentiated service code point (“DSCP”), may be assigned to messages to provide an indication of priority as compared to other messages. This enables the network to transmit higher priority messages over lower priority messages in the case of reduced network performance.

Conventionally, the specific priority level indicated by the priority markings is determined by the designated component of the network a particular message is originating from. For example, all messages originating from a particular NF, such as the SMF, will receive the same level of priority. As a result, messages originating from the same source component each have the same level of priority, despite differences in message type or which interface the message is to be routed on (i.e., which NF the message is to be sent to). Messages originating from the same component, for example from the same NF, may have varying levels of importance, yet are all marked with the same level of priority. As a result, a bottle neck may occur during an outage or reduced network performance from attempts to prioritize one message over another, as both messages originate from the same component and have the same priority marking.

In contrast to conventional solutions and to facilitate a more optimized use of the 5G core network, the present disclosure is directed to assigning customized priority markings to messages based on the type of message being sent and/or the interface the message is sent on. For example, messages relating to registration sent between the SMF and the PCF on the N7 interface may have a different priority marking than messages relating to de-registration on the same interface. Further, on the N8 interface between the AMF and the UDM, a registration message may have a different priority marking than a registration message on the N7 interface. Under current solutions, a bottleneck may occur in the event of a network outage, as messages of equal priority cannot be prioritized. This solution provides a more tailored approach to managing and enforcing priority markings of messages between network components.

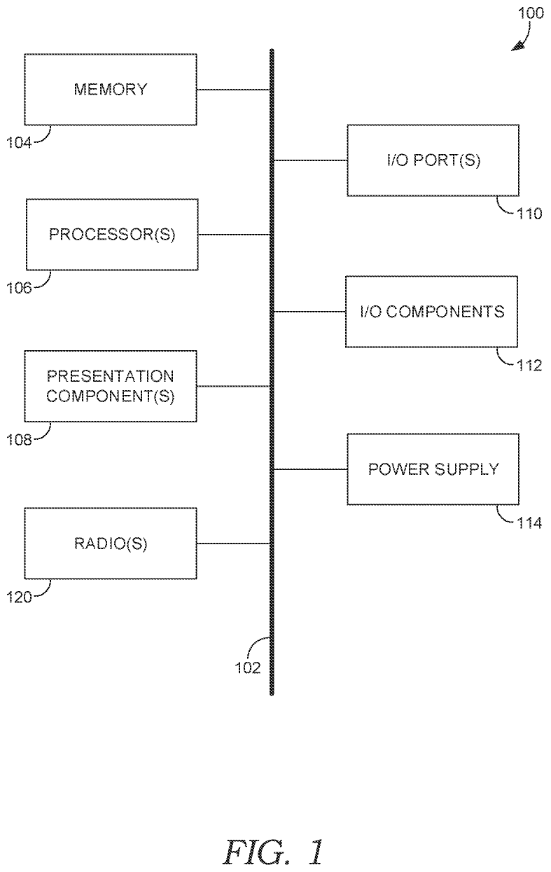

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VOLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

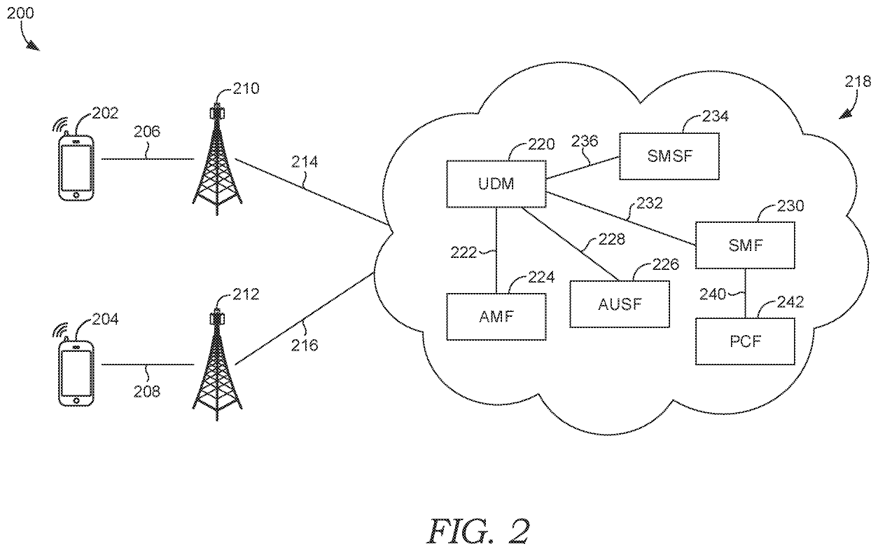

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as a first UE 202 and/or a second UE 204, one or more base stations, such as a first base station 210 and/or a second base station 212, and a core network 218, though in some implementations, it may not be necessary for certain features to be present. For example, in some aspects, the network environment 200 may not comprise the second base station 212 where the first UE 202 and the second UE 204 connect to the first base station 210. The network environment may include a number of routers, switches, and the like. The network environment 200 is generally configured for wirelessly connecting the first UE 202 and/or the second UE 204 to data or services that may be accessible on one or more application servers or other functions, nodes, or servers not pictured in FIG. 2 so as to not obscure the focus on the present disclosure.

The network environment 200 comprises one or more of the first UE 202 and the second UE 204. The first UE 202 and the second UE 204 are illustrated generally, and may take any number of forms, including a tablet, phone, or wearable device, or any other device discussed with respect to FIG. 1 and may have any one or more components or features of the computing device 100 of FIG. 1. In some aspects, the first UE 202 and/or the second UE 204 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The network environment 200 comprises one or more of the first base station 210 and/or the second base station 212 to which the first UE 202 and the second UE 204 may potentially connect to (also referred to as ‘camping on,’ ‘attaching,’ in the industry). Though network environment 200 is illustrated with both the first base station 210 and the second base station 212, one skilled in the art will appreciate that more or fewer base stations may be present in any particular network environment. Each of the first base station 210 and the second base station 212 of the network environment 200 is configured to wirelessly communicate with UEs, such as the first UE 202 and/or the second UE 204. In aspects, any of first base station 210 and the second base station 212 may communicate with one or more of the first UE 202 and/or the second UE 204 using any wireless telecommunication protocol desired by a network operator, including but not limited to 3G, 4G, 5G, 6G, 802.11x and the like.

Each base station of the first base station 210 and the second base station 212 is configured to transmit and receive one or more of a first signal 206 and/or a second signal 208 between a base station and the first UE 202 and between a base station and the second UE 204. The one or more of the first signal 206 and the second signal 208 comprise one or more uplink signals for which the first base station 210 and/or the second base station 212 are configured to receive from the first UE 202 and/or second UE 204. The one or more of the first signal 206 and the second signal 208 may also comprise downlink signals for which the first base station 210 and/or the second base station 212 are configured to receive from the first UE 202 and/or the second UE 204. In response to receiving certain requests from the first UE 202 and/or the second UE 204, the first base stations 210 and/or the second base station 212 may communicate with the core network 218 via a first backhaul 214 and a second backhaul 216. For example, in order for the first UE 202 to connect to a desired network service (e.g., PSTN call, voice over LTE (VOLTE) call, voice over new radio (VoNR), data, or the like), the first UE 202 may communicate an attach request to the first base station 210, which may, in response, communicate a registration request to the core network 218 via the first backhaul 214.

One or more network functions (NFs) of the core network 218 may communicate messages across the core network 218 to other NFs of the core network 218. As used herein, the term “network function” is used to describe a computer processing module and/or one or more computer executable services being executed on one or more computing processing modules. For example, the core network 218 may comprise NFs that include any one or more of a unified data management function (UDM) 220, an access and mobility management function (AMF) 224, an authentication server function (AUSF) 226, a session management function (SMF) 230, a short message service function (SMSF) 234, and a policy control function (PCF) 242. Notably, the preceding nomenclature is used with respect to the 3GPP 5G architecture; in other aspects each of the preceding NFs may take different forms, including consolidated or distributed forms that perform the same general operations. For example, the PCF 242 in the 3GPP 5G architecture is generally configured for various functions relating to policy management and enforcement; in other forms, such as a 4G architecture, the PCF 242 of FIG. 2 may take the form of a policy and charging rules function (PCRF). In other architectures or protocols, the NFs may be given other names, however, the NFs herein refer to functions, not specifically identified components. Though the UDM 220, the AMF 224, the AUSF 226, the SMF 230, the SMSF 234, and the PCF 242 are illustrated in the core network 218, the core network 218 may have more or fewer NFs than shown. For example, the core network 218 may include a network slice selection function (NSSF). Further, though the UDM 220, the AMF 224, the AUSF 226, the SMF 230, the SMSF 234, and the PCF 242 are illustrated as disposed within the core network 218 it is expressly contemplated that the location in the network environment 200 is non-limiting. For example, the NFs described above may be disposed between the first base station 210 and/or the second base station 212 and the core network 218 (i.e., the network edge) or may be isolated as stand-alone components, or a combination of these.

The network core 218 is a service-based architecture and contains NFs defined by their function. The UDM 220, for example, is generally responsible for managing user data within the network. The AMF 224, for example, is generally responsible for managing registration and mobility of UEs, such as the first UE 202 and/or the second UE 204, and achieves this by coordinating signaling between UEs, such as the first UE 202 and/or the second UE 204, and other NFs. The AUSF 226, for example, is generally responsible for authenticating a UE, such as the first UE 202 or the second UE 204. The SMF 230, for example, is generally responsible for managing sessions between the network and one or more UEs, such as the first UE 202 and the second UE 204. The PCF 242, for example, are generally responsible for providing and enforcing policy information, such as the restrictions and requirements of subscriber agreements. The SMSF 234, for example, is generally responsible for the transmission of SMS messages between UEs, such as the first UE 202 and the second UE 204, in the network and outside of the network.

NFs within the core network 218 communicate a variety of messages to each other to perform their associated functions. For example, messages may correspond to registering a UE (such as the first UE 202 and the second UE 204) with the network, registering of a service provided by an NF, requesting information from the destination NF, providing information to the source NF, subscribing to notifications from an NF, providing notifications to NFs that an event has occurred, requesting deletion of specific information stored by an NF, and the like. Information given or provided by NFs to other NFs may include subscription information associated with a particular subscriber of the network, session information associated with a particular session in the network, information associated with authentication of a UE (such as the first UE 202 and the second UE 204), and/or information associated with the level of traffic experienced by an NF, for example.

Network protocols control the format of messages exchanged between NFs along interfaces. Messages between NFs may be configured to hypertext transfer protocol 2 (HTTP/2), which provides a standard message format for network components to recognize. The format of a message between NFs may include a header, a payload, and a trailer that follows the payload, each of which may provide information to the network. The header of a message may include various fields such as a message identifier that may be identified by various network components, a priority marking (such as a differentiated service code point (DSCP)) indicating a priority level of the message, configuration parameters, source and destination component identifiers, and the like. In some examples, the header may include the message type, such as a registration message, and/or the priority marking; in other examples, the payload may include the message type and/or the priority marking. The message also includes a trailer, which may include additional information about the message or signal the end of a transmission. In some examples, the priority marking may be found in the trailer of the message.

The NFs within the core network 218 communicate with other NFs to perform specified functions via designated interfaces. An interface is a connection point between NFs and allows NFs to bi-directionally communicate messages to other NFs. Particular interfaces are associated with specific NF pairs. For example, communications between the AUSF 226 and the UDM 220 occur on an N13 interface 228, while communications between the AMF 224 and the UDM 220 occur on an N8 interface 222. Further, for example, communications between the UDM 220 and the SMF 230 occur on an N10 interface 232, communications between the UDM 220 and the SMSF 234 occur on a N21 interface 236, and communications between the SMF 230 and the PCF 242 occur on a N7 interface 240. Essentially, the interface a message will travel across depends on which NFs the message is between.

In certain instances, a network may experience network failures caused by various network events. For example, network congestion, a cut fiber or other wired connection, IP link failures, a reduced quality of service, an outage, or some other network event may cause network failures or delays. As a result, messages may be lost or delayed in their transmission between NFs or between servers or between other network components. For example, a router or a switch at the IP layer may experience a network failure when its central processing unit (CPU) percentage exceeds 90%, preventing transmission of data or causing a backup of messages in a queue. In other examples, a natural disaster such as a hurricane may disrupt an entire network, causing delays in data transmission across the network. Priority markings assist the network in determining what messages across what interfaces are most important, and should be prioritized for transmission as compared to lower priority messages.

Traffic parameters provide the network with measurements of traffic, and a pre-determined traffic threshold may assist the network in determining whether an outage, a reduced quality of service, or some other network failure in performance is occurring. A pre-determined traffic threshold may establish a level or value of a traffic parameter that, when exceeded, indicates high traffic, a reduced quality of service, a network outage, and the like. Traffic parameters may include an amount of bandwidth in use, an amount of data packets lost during transmission, an amount of time for a data packet to travel from a source to its destination, an amount of concurrent connections or sessions within the network, an amount of errors occurring within the network, network component performance data, and the like. It is expressly contemplated that multiple traffic parameters may be utilized in creating a single pre-determined traffic threshold and that a network may utilize a number of different traffic thresholds. Traffic parameters may be monitored by network traffic monitoring tools or systems to determine when the pre-defined traffic threshold has been exceeded, or the traffic parameters may be monitored by other network components, such as IP layer switches and/or routers, a service communications proxy (SCP), a gateway, a firewall, a load balancer, and the like.

Relevant to the present disclosure, priority markings, such as differentiated services code points (DSCPs), may be assigned to messages between NFs based on a set of pre-defined rules defining what priority marking may be assigned based on the interface and/or the message itself. For example, a set of pre-defined rules may be executed or employed by network components and may define which priority marking (i.e., level of priority) should be assigned based on the interface involved, such as the N8 interface 222 between the UDM 220 and the AMF 224, and/or what the message is, such as a registration message. For example, a registration message on the N7 interface 240 (i.e., between the SMF 230 and the PCF 242) may have a different priority marking than a de-registration message on the same N7 interface 240. Further, for example, a registration message on a N8 interface 222 (i.e., between the AMF 224 and the UDM 220) may have a different priority marking than a similar registration message on the N7 interface 240. In another example, a registration message on the N7 interface 240 may have a priority marking different than a “get” message on the N8 interface 222. In some examples, some messages may have the same priority marking indicating they have the same level of priority, despite being different message type and/or being communicated on a different interface.

A priority marking assigned to a message may indicate the message should be afforded higher priority or lower priority than other messages with different assigned priority markings. In some examples, the priority marking has a numerical value and the smaller the numerical value of the priority marking, the higher the priority. For example, lower DSCP values may indicate a higher level of priority, and higher DSCP values may indicate a lower level of priority. In other examples, the higher the numerical value of the priority marking, the higher priority. In other examples, the priority marking is not numerical, but instead alphabetic. For example, priority markings could include “high priority,” “medium priority,” “low priority,” “urgent,” “important,” “not important,” “best effort,” “assured forwarding,” and/or “expedited forwarding.” It is expressly contemplated that the indication of priority given by the priority marking may vary in its form, and may include numerical, alphabetical, and/or a combination of numerical and alphabetical values.

A priority marking may be assigned before or after the outage or reduced quality of service occurs. The priority message may be assigned by default in every message, or the network may wait to assign priority markings until after a network event triggers assignment, or a combination of these. In some examples, assigning priority markings to all messages by default allows the network to quickly act in the event of an outage, and can quickly route messages based on existing priority markings as soon as the outage occurs. In other examples, assigning priority markings after an outage or other network event occurs allows the network to save substantial resources until an outage or reduced quality of service actually occurs. In some examples, assigning only the highest priority markings by default, but not lower priority messages, allows the network to both act quick and save some resources until complete assignment of priority messages is necessary.

A network component may assign the priority marking to a message. In some examples, the network component may be an IP-layer switch and/or router. In other examples, the network component may be an NF, a firewall, a load balancer, a gateway, a server, a SCP and/or any network component configured to assign priority markings. The network component may assign the priority marking in various ways. For example, the priority marking may be assigned by creating or modifying a header associated with the message to include the priority marking, creating or modifying a payload associated with the message to include the priority marking, creating or modifying a trailer associated with the message to include the priority marking, or a combination of these.

Priority markings assigned to messages may affect its place in a queue of messages waiting to be sent. A queue within a network acts as a buffer to store messages for outgoing transmission. In some examples, priority markings may affect queuing decisions only when the network is facing reduced performance, an outage, and the like, and in other examples, priority markings may affect queuing decisions in sunny day conditions. The queue may be formed by many different network components, including an IP layer switch and/or router, an SCP, an NF, a firewall, a load balancer, a gateway, a server, and the like. There may be one central queue in a network, or there may be various queues associated with individual network components. The order of the messages (i.e., which messages are placed in line for transmission before others) within the queue are determined by various factors. For example, the priority marking assigned to the message, the size of the message, the bandwidth allocation percentage, and/or the level of quality of service available may inform organization of the queue. For example, when a network is experiencing an outage or reduced quality of service, there is not enough network resources to continue routing messages, and network components may rely on priority markings to assist in forming a queue, such as by placing messages with priority markings indicating a higher priority ahead of other messages with priority markings indicating a lower priority for outgoing transmission.

Priority marking assigned to messages may affect routing decisions made by network components. In some examples, priority markings may affect routing decisions only when the network is facing reduced performance, an outage, and the like, and in other examples, priority markings may affect routing decisions in sunny day conditions. Various network components may be generally responsible for making routing decisions regarding messages to be communicated between NFs. For example, an IP layer switch and/or router may decide when to allow queued messages to be transmitted. In some examples, the same network component responsible for making routing decisions also physically routes the message, and in other examples, a different network component will route the message in response to the network component determining when to allow the message to be transmitted. For example, a SCP may make the routing decision, but an IP layer switch and/or router may actually route the message, or the SCP may both make the decision and route the message. In making routing decisions and routing the message, network components may rely on priority markings that indicate a level of priority to give a particular message. Based on priority markings, network components may route messages with priority markings indicating a higher priority before other messages with priority markings indicating a lower priority, or network components may elect to route the higher priority message and drop the lower priority message.

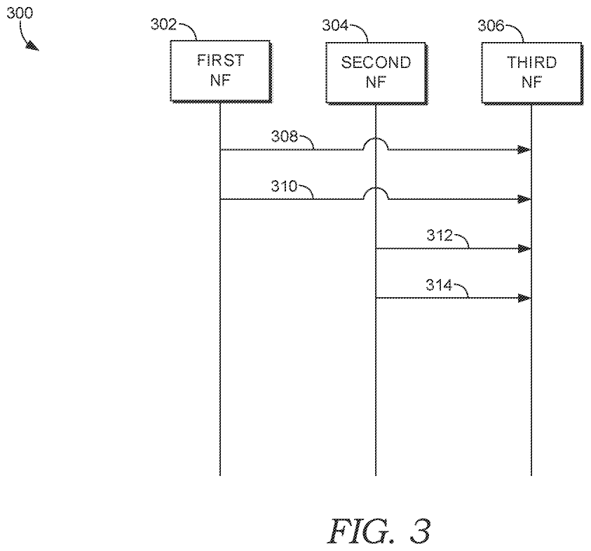

Turning now to FIG. 3, a call flow diagram is illustrated in accordance with one or more aspects of the present disclosure. A call flow 300 may be said to exist between one or more NFs discussed in greater detail herein and is not meant to exhaustively show every interaction that would be necessary to practice the invention, so as not to obscure the present disclosure, but is instead meant to illustrate one or more potential interactions between NFs. The call flow 300 may be relevantly said to include a first NF 302, a second NF 304, and a third NF 306. In some aspects, the second NF 304 and the third NF 306 may be any NF consumer requesting information from the first NF 302. For example, the first NF 302 may be a UDM (such as the UDM 220 of FIG. 2), the second NF 304 may be a SMF (such as the SMF 230 of FIG. 2), and the third NF 306 may be an AMF (such as the AMF 224 of FIG. 2). Notably, the preceding nomenclature is used with respect to the 3GPP 5G architecture; in other aspects, each of the preceding NF components may take different forms, including consolidated or distributed forms that perform the same general operations. In other examples, the first NF 302, the second NF 304, and the third NF 306 are servers.

FIG. 3 illustrates a number of messages attempting to be sent between NFs during a network outage or reduced quality of service. A network component, such as an IP layer switch and/or router, may decide when to route or queue the messages based on a priority marking of the message. At a first step 308, the first NF 302 may attempt to send a first message to the third NF 306. The first message may be assigned a first priority marking of 8, for example. At a second step 310, the first NF 302 may attempt to send a second message to the third NF 306. The second message may be assigned a second priority marking of 5, for example. For purposes of FIG. 3, the higher the value of the priority marking, the higher priority, however, it is expressly contemplated that the priority marking may be evaluated using different methods as discussed with respect to FIG. 2. The network component may find the first priority marking of the first message indicates a higher priority than the second priority marking of the second message and alter routing or queuing decisions accordingly. For example, the network component may route the first message before it routes the second message. In some examples, the network component may elect to drop or queue the second message and only route the first message. In other examples, the network component may elect to place the first message ahead of the second message in a queue of messages waiting to be sent.

The first NF 302 and the third NF 306 may be a number of different NFs in a network, and the first message and second message may be a number of different message types. For example, the first NF 302 may be a UDM (such as the UDM 220 of FIG. 2) and the third NF 306 may be an AMF (such as the AMF 224 of FIG. 2), and the first message and the second message may both be communicated across a N8 interface (such as the N8 interface 222 of FIG. 2). In this example, the first message may comprise an “Nudm_UECM_Registration” message type, which may have a priority marking reflecting a higher priority than the second message that may comprise an “Nudm_UECM_DeRegistration” message type. In this example, priority markings based on the type of message control, rather than the interface, as both the first message and the second message were communicated via the same N8 interface.

At a third step 312, the second NF 304 may attempt to send a third message to the third NF 306. The third message is assigned a third priority marking of 6, for example. At a fourth step 314, the second NF 304 may attempt to send a fourth message to the third NF 306. The fourth message is assigned a fourth priority marking of 3, for example. A network component, such as an IP layer switch and/or router, may find the third priority marking of the third message indicates a higher priority than the fourth priority marking of the fourth message and alter routing and/or queuing decisions in response. For example, the network component may route the third message before it routes the fourth message. In some examples, the network component may elect to drop or queue the fourth message and only route the third message. In other examples, the network component may elect to place the third message ahead of the fourth message in a queue of messages waiting to be sent.

The second NF 304 and the third NF 306 may be a number of different NFs in a network, and the third message and the fourth message may be a number of different message types. For example, the second NF 304 may be a SMF (such as the SMF 230 of FIG. 2), and the third NF 304 may be a UDM (such as the UDM 220 in FIG. 2), and the third message and the fourth message may both be communicated across a N10 interface (such as the N10 interface 232 of FIG. 2). In this example, the third message may comprise an “Nsmf_PDUSession_ReleaseSMContext Response” message type, which may have a priority marking indicating a higher priority than the fourth message comprising an “Nsmf_PDUSession_UpdateContext Response” message type. In this example, priority markings based on the type of message control priority, rather than the interface, as both the third message and the fourth message are communicated via the same N11 interface.

In another illustrative example, the first message, the second message, the third message, and the fourth message are all attempting to be transmitted during a network outage or reduced quality of service. The first message and the second message are different message types and both are to communicate across a first interface (i.e., between the first NF and the third NF). The third message and the fourth message are different message types and both are to communicate across a second interface (i.e., between the second NF and the third NF). The first message and the third message are both registration messages. The priority marking may reflect an the importance of both message type and the interface involved. For example, the first message may have a priority marking indicating a higher priority than the third message, based solely on the interface it will travel (i.e., which NFs the message is between), as the first message and the third message are the same type of message. However, the third message may be a higher priority than the second message, based on both the type of message and the interface it will travel, as each message is a different type and the interface each message will travel is different. In some examples, priority markings may indicate the same or a similar indication of priority between message types and interfaces.

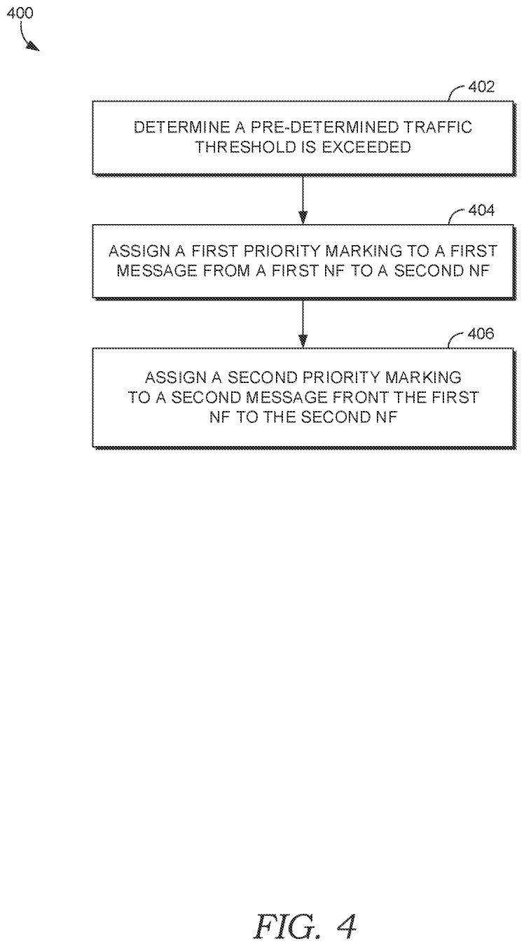

Turning now to FIG. 4, a flow chart is provided that illustrates one or more aspects of the present disclosure relating to a method 400 for assigning priority markings to messages. In some aspects of the present disclosure, a traffic threshold is exceeded before assignment of priority markings occurs, thus saving network resources spent assigning priority markings until after the pre-determined traffic threshold is reached. At a first step 402, a first network component determines a pre-determined traffic threshold is exceeded. The traffic threshold may indicate an outage, a reduced quality of service, or another network event triggering prioritization of messages. At a second step 404, a second network component, in response to finding the pre-determined traffic threshold was reached, assigns a first priority marking to a first message from a first NF to a second NF. At a third step 406, the second network component assigns a second priority marking to a second message from the first NF to the second NF. The second network component may be the same component as the first network component as described in the first step 402 or it may be a different network component. For example, the first network component may be an IP layer switch and/or router or a network traffic monitoring system, and the second network component may be an SCP, or, in other examples, the first network component and second network component may both be an IP layer switch and/or router.

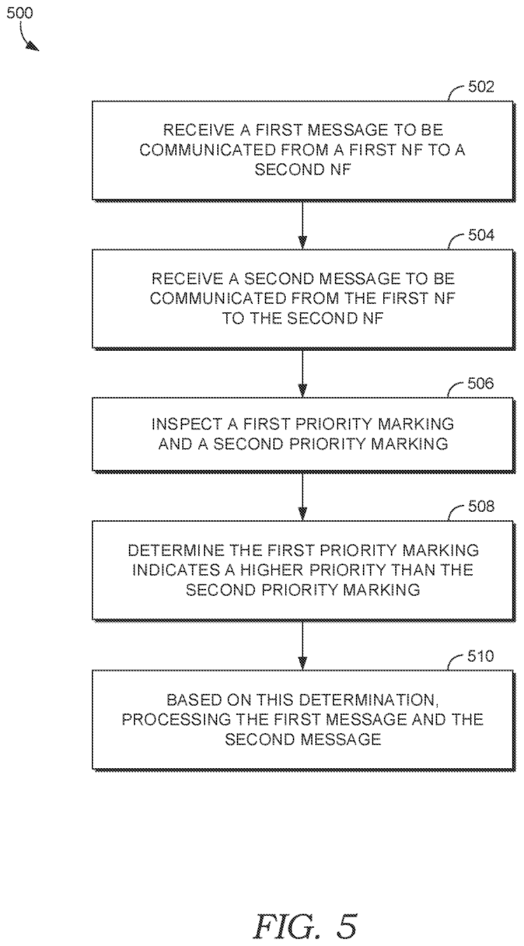

Turning now to FIG. 5, a flow chart is provided that illustrates one or more aspects of the present disclosure relating to a method 500 for processing a higher priority message. In some aspects of the present disclosure, messages may be assigned priority markings by default, regardless of a traffic threshold being exceeded. At a first step 502, a first network component receives a first message to be communicated from a first NF to a second NF. The first message is already assigned a first priority marking. At a second step 504, the first network component receives a second message to be communicated from a first NF to a second NF. The second message is already assigned a second priority marking. At a third step 506, a second network component inspects the first priority marking and inspects the second priority marking. In some examples, the first network component and the second network component are the same, and in other examples, the first network component and the second network component are different components. For example, the first network component may be an IP layer switch and/or router, and the second network component may be an SCP, or, in other examples, the first network component and second network component may both be an IP layer switch and/or router.

At a fourth step 508, the second network component determines the first priority marking indicates a higher priority than the second priority marking. For example, the second network component may find a numerical value associated with the first priority marking exceeds a numerical value associated with the second priority marking. In other examples, the second network component may find an alphabetical representation of the first priority marking is classified as a higher priority than an alphabetical representation of the second priority marking, such as the first priority marking being “highest priority,” and the second priority marking being “high priority.” At a fifth step 510, and upon determining the first priority marking indicates a higher priority than the second priority marking, a third network component processes the first message and the second message. In some examples, the second network component and the third network component are the same component, and in other examples, the second network component and the third network component are different components. In some examples, processing the first message and the second message may include routing the first message for transmission before the second message. In other examples, processing the first message and the second message may include dropping or queuing the second message and only routing the first message. In other examples, processing the first message and the second message includes placing the first message ahead of the second message in a queue of messages waiting to be sent.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for managing messages between two or more network functions (NFs) in a core network of a mobile communication network, the method comprising:
determining a pre-determined traffic threshold is exceeded on the mobile communication network;
based on the determination, assigning a first priority marking to a first message to be communicated from a first NF to a second NF; and
based on the determination, assigning a second priority marking to a second message to be communicated from the first NF to the second NF.

2. The method of claim 1, wherein the pre-determined threshold of traffic is exceeded on the first NF.

3. The method of claim 1, wherein the pre-determined threshold of traffic is exceeded on the second NF.

4. The method of claim 1, further comprising processing the first message and the second message based on the first priority marking being higher priority than the second priority marking.

5. The method of claim 4, wherein processing the first message and the second message comprises routing the first message before the second message based on the first priority marking being higher priority than the second priority marking.

6. The method of claim 4, wherein processing the first message comprises queuing the first message ahead of the second message for transmission based on the first priority marking being higher priority than the second priority marking.

7. The method of claim 4, wherein the first priority marking and the second priority marking are each a differentiated service code point (DSCP) marking.

8. A method for managing messages between two or more network functions (NFs) in a core network of a mobile communication network, the method comprising:
receiving a first message to be communicated from a first NF to a second NF;
receiving a second message to be communicated from a first NF to a second NF;
determining that a pre-determined traffic threshold is exceeded;
inspecting the first message to discover a first priority marking and inspecting the second message to discover a second priority marking, the first priority marking indicates a higher priority than the second priority marking; and
based on the determination and the inspection of the first message and the second message, processing the first message and the second message.

9. The method of claim 8, wherein processing the first message and the second message comprises routing the first message to the second NF before the second message.

10. The method of claim 8, wherein processing the first message and the second message comprises queuing the first message for transmission to the second NF ahead of the second message.

11. The method of claim 8, wherein the first priority marking and the second priority marking are each a differentiated service code point (DSCP) marking.

12. The method of claim 8, wherein the pre-determined traffic threshold is exceeded on the first NF.

13. The method of claim 8, wherein the pre-determined traffic threshold is exceeded on the second NF.

14. A system for managing messages between two or more servers in a data network, the system comprising:
one or more computer processing components configured to execute operations comprising:
assigning a first priority marking to a first message to be communicated from a first server to a second server;
assigning a second priority marking to a second message to be communicated from a first server to a second server, wherein the first marking is different than the second marking; and
processing the first message and the second message based on the first priority marking and the second priority marking.

15. The system of claim 14, wherein the first priority marking and the second priority marking is a differentiated service code point (DSCP) marking.

16. The system of claim 14, wherein processing the first message and the second message is in response to determining that a pre-determined traffic threshold is exceeded.

17. The system of claim 14, wherein the first priority marking indicates a higher priority than the second priority marking.

18. The system of claim 14, wherein the first server is a network function (NF) and the second server is an NF.

19. The system of claim 17, wherein processing the first message and the second message comprises routing the first message to the second server before the second message.

20. The system of claim 17, wherein processing the first message and the second message comprises queuing the first message for transmission to the second server ahead of the second message.
